(19) United States
(12) Patent Application Publication
(10) Pub. No.: US 2012/0224771 A1
(43) Pub. Date: Sep. 6, 2012

(54) IMAGE PROCESSING SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/291,164

(22) Filed: Nov. 8, 2011

(30) Foreign Application Priority Data
Mar. 2, 2011 (TW) 100107001

(51) Int. Cl. G06T 5/40

(52) U.S. Cl. 382/168

(57) ABSTRACT

An image processing system and an image processing method are disclosed. The image processing method executable on a computer, the image processing method comprises obtaining an image; obtaining an intermediate image by scaling down the image; calculating an image level distribution of the intermediate image; determining a relatively small image level and a relatively large image level based on the image level distribution; and adjusting image levels of pixels of the image according to the relatively small image level and the relatively large image level.

### BACKGROUND

1. Technical Field

The disclosure generally relates to an image processing system and an image processing method.

2. Description of Related Art

A typical display device displays an image using a fixed range of luminance levels. For many displays, the luminance range has 256 levels which are uniformly spaced from 0 to 255. Image level values are generally assigned to match these levels directly. Thus, an image has a plurality of pixels, which are denoted by image levels, namely 0, 1, 2, . . . , 255. For example, in an 8-bit image displaying system, the image level value 0 denotes the minimum luminance level and the image level value 255 denotes the maximum luminance level. Due to different environmental conditions or photographic errors, the captured images can sometimes be too dark or too bright. For example, if the environmental condition is too bright, the captured images may look too bright accordingly. Therefore, there is a need for a technique adjusting the overexposed or underexposed images.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of an electronic device suitable for use in implementing an image processing system according to one embodiment of the present disclosure.

FIG. 2 is a schematic diagram of the function modules of the image processing system of FIG. 1.

FIG. 3 shows an example of an image level histogram of a first intermediate image.

FIG. 4 shows another example of an image level histogram of a second intermediate image.

FIG. 5 shows another example of an image level histogram of a third intermediate image.

FIG. 6 is an operational flow diagram for processing images according to one embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

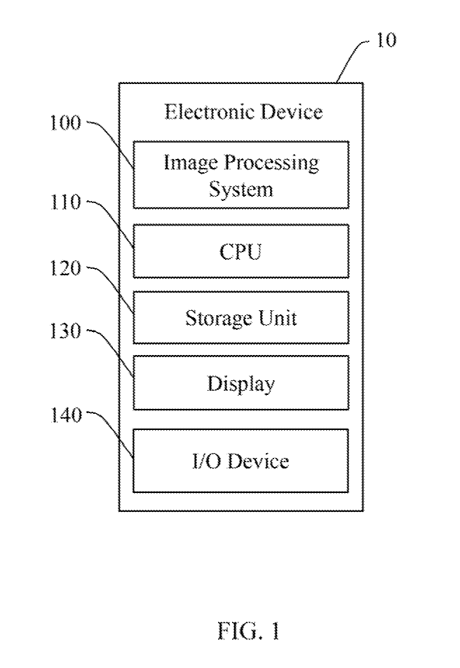

FIG. 1 is a schematic diagram of an electronic device 10 according to one embodiment. The electronic device 10 can include an image processing system 100, at least one central processing unit (CPU) 110, a storage unit 120, a display 130, and other Input/Output (I/O) devices 140. The electronic device 10 can implement functions of the image processing system 100. The electronic device 10 can be a general purpose computing device such as a desktop computer, a tablet computer, a personal digital assistant (PDA), or a smart phone.

The storage unit 120 may be any form of volatile or non-volatile storage, including, for example, RAM, ROM, EPROM, flash memory, a magnetic disk such as an internal hard disk or a removable disk, an optical disk such as a CD-ROM, or any other storage which can be used to store the desired information and which can be accessed by the image processing system 100. The storage unit 120 may store machine-executable instructions, data, and various programs, such as an operating system and one or more application programs, all of which may be processed by the CPU 110. The display 130 can be a liquid crystal display (LCD) or a cathode-ray tube (CRT) display. The electronic device 10 may include one or more I/O devices 140 such as a keyboard, a mouse, a touch pad, or other pointing device. The storage unit 120, the display 130 and the other I/O devices 140 are connected to the CPU 110 through a system bus (not shown in FIG. 1).

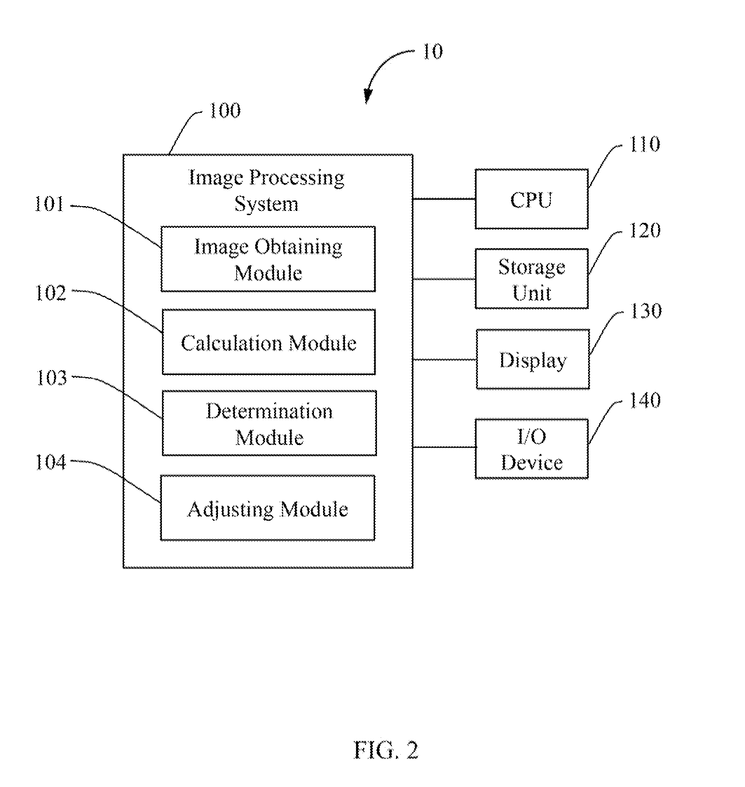

FIG. 2 illustrates a schematic diagram of the function modules of the image processing system 100. The image processing system 100 can include an image obtaining module 101, a calculation module 102, a determination module 103, and a adjusting module 104. Each of the modules 101-104 may be a software program including one or more computerized instructions which are stored in the storage unit 120 and executed by the CPU 110.

The image obtaining module 101 may load an original image from a local source such as a file folder in the storage unit 120, for example, “X:\photos\”. The image obtaining module 101 may also obtain an original image from a remote source such as in an image website via the Internet. The original images may be in a variety of supported formats such as JPEG, GIF, PNG, TIFF, and Bitmap. The image obtaining module 101 may scale down the original image and produce an intermediate image, of which the total number of pixels is smaller than the total number of pixels of the original image. Reduction of the total number of pixels from the original image to the intermediate image can have an advantage that the image processing system 100 is able to use less time to process the intermediate image than the original image.

The calculation module 102 may calculate an image level distribution of the intermediate image. The calculation module 102 may generate an image level histogram displaying the image level distribution, where an abscissa axis of the image level histogram represents image levels and an ordinate axis of the image level histogram represents the number of pixels of each of the image levels.

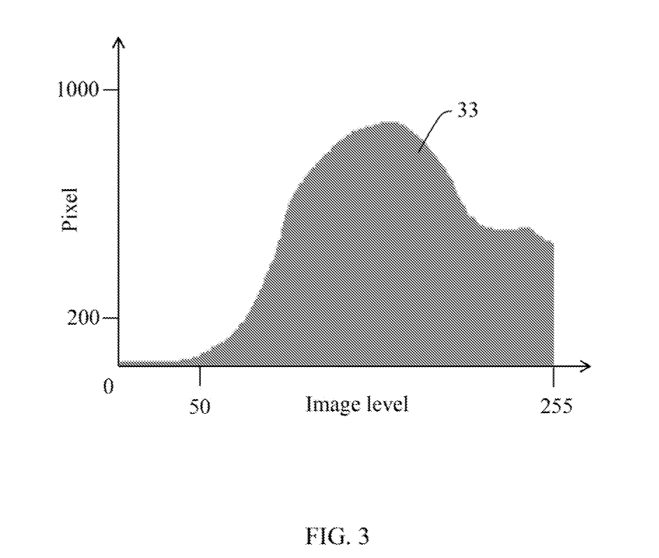

FIG. 3 shows an example of the image level histogram of a first intermediate image generated by the calculation module 102. The x-axis represents image levels of an intermediate image, and the y-axis represents a number of pixels, and an image level histogram is a statistical chart primarily illustrating the number of pixels in each image level. Therefore, the image level histogram of FIG. 3 tells the image level distribution conditions of the first intermediate image. Furthermore, the intermediate image is obtained by scaling down the original image. Thus the image level histogram may also be used for describing the characteristics of the original image. The highlighted area 33 under the curve of the image level histogram represents a total number of pixels of the first intermediate image. In FIG. 3, a range of image levels is from 0 to 255. In other words, the first intermediate image has a lower limit image level, L_{low}, of 0, and an upper limit image level, Lᵤₚ, of 255.

The determination module 103 may determine a relatively small image level, P₁, and a relatively large image level, P₂, based on the image level distribution of the intermediate image. The determination module 103 may determine the relatively small image level P₁ by scanning the level histogram along the abscissa axis from left to right until the number of pixels reaches a first threshold value. The first threshold value is equal to the total number of pixels of the intermediate image multiplied by a first predetermined percentage. The determination module 103 may determine the relatively large image level P₂ by scanning the level histogram along the abscissa axis from right to left until the number of pixels reaches a second threshold value. The second threshold value is equal to the total number of pixels of the intermediate image multiplied by a second predetermined percentage.

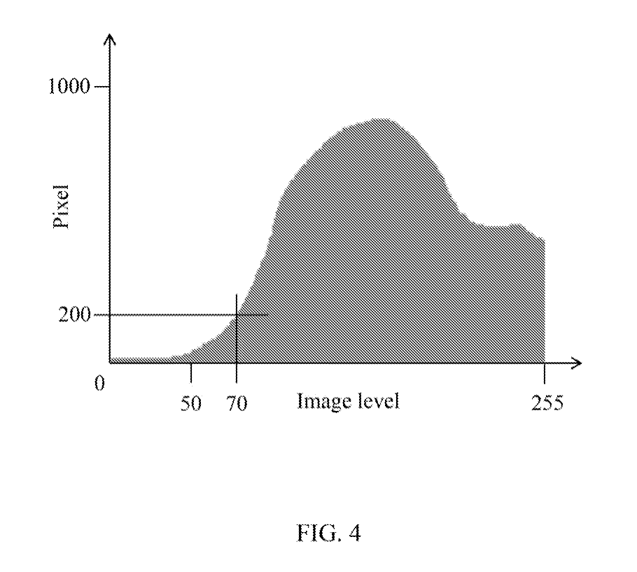

Another example in FIG. 4 shows the second intermediate image having a total of 10,000 pixels. In one embodiment, the first predetermined percentage and the second predetermined percentage are both set as 2%. Thus the first threshold value and the second threshold value are both equal to 200. The determination module 103 scans the level histogram along the x-axis from left to right and determines that the relatively small image level P₁ of the second intermediate image is 70. When the determination module 103 scans the level histogram along the x-axis from right to left, the determination module 103 can find that the number of pixels at an image level value of 255 has exceeded the second threshold value 200. The determination module 103 may determine that the relatively large image level P₂ of the second intermediate image is 255.

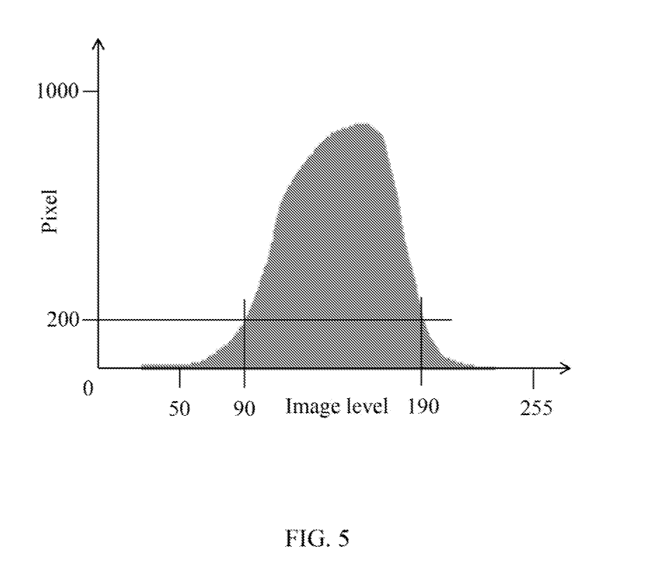

FIG. 5 illustrates another example of the image level histogram of the third intermediate image, which has a total of 10,000 pixels. In one embodiment, the first predetermined percentage and the second predetermined percentage are both set as 2%. Thus the first threshold value and the second threshold value are both equal to 200. The determination module 103 scans the level histogram along the x-axis from left to right and determines that the relatively small image level P₁ of the third intermediate image is 90. The determination module 103 scans the level histogram along the x-axis from right to left and determines that the relatively large image level P₂ of the third intermediate image is 190.

The adjusting module 104 may adjust image levels of pixels of the original image according to the relatively small image level P₁ and the relatively large image level P₂. The adjusting module 104 may produce an object image by adjusting image levels of pixels of the original image according to either the relatively small image level P₁ or the relatively large image level P₂ The adjusting module 104 may produce a final modified image by further adjusting image levels of pixels of the object image according to a remaining one of the relatively small image level P₁ or the relatively large image level P₁

The adjusting module 104 may modify image level of each pixel of an input image (either the original image or the object image), Lᵢₙ, according to the relatively small image level, P₁, by using an equation as follows:

$$\{ \begin{matrix}{L}_{out} = {L}_{low} , & ( {L}_{in} \leq {P}_{1} ) \\ {L}_{out} = {L}_{low} + ( {L}_{up} - {L}_{low} ) ( {L}_{in} - {P}_{1} ) / ( {L}_{up} - {P}_{1} ) , & ( {L}_{in} > {P}_{1} )\end{matrix}$$

where Lₒᵤₜ represents a modified image level, Lᵢₙ represents an input image level, P₁ represents the relatively small image level, L_{low} represents the lower limit image level, Lᵤₚ represents the upper limit image level.

The adjusting module 104 may modify image level of each pixel of an input image level (either the original image or the object image), Lᵢₙ, according to the relatively large image level, P₁, by using an equation as follows:

$$\{ \begin{matrix}{L}_{out} = {L}_{up} , & ( {L}_{in} \geq {P}_{2} ) \\ {L}_{out} = {L}_{low} + ( {L}_{up} - {L}_{low} ) ( {L}_{in} - {L}_{low} ) / ( {P}_{2} - {L}_{low} ) , & ( {L}_{in} < {P}_{2} )\end{matrix}$$

where Lₒᵤₜ represents a modified image level, Lᵢᵢ represents an input image level, P₂ represents the relatively large image level, L_{low} represents the lower limit image level, Lᵤₚ represents the upper limit image level.

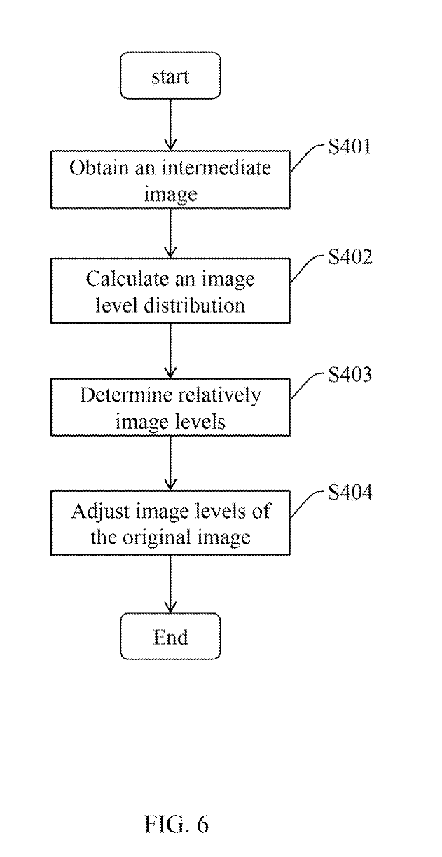

FIG. 6 is a flowchart of processing image using the image processing system of FIG. 1. The method may comprise the following steps:

In step S401, the image obtaining module 101 loads an original image from a local source or a remote source and produce an intermediate image by scaling down the original image.

In step S402, the calculation module 102 calculates an image level distribution of the intermediate image and generates an image level histogram displaying the image level distribution, where an abscissa axis of the image level histogram represents image levels and an ordinate axis of the image level histogram represents the number of pixels of each of the image levels.

In step S403, the determination module 103 determines a relatively small image level P₁ and a relatively large image level P₂ based on the image level histogram.

In step S404, the adjusting module 104 adjusts image levels of pixels of the original image according to the relatively small image level P₁ and the relatively large image level P₂.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. An image processing method executable on a computer, the image processing method comprising:
obtaining an image;
obtaining an intermediate image by scaling down the image;
calculating an image level distribution of the intermediate image;
determining a relatively small image level and a relatively large image level based on the image level distribution; and
adjusting image levels of pixels of the image according to the relatively small image level and the relatively large image level.

2. The image processing method of claim 1 further comprises generating an image level histogram displaying the image level distribution, wherein an abscissa axis of the image level histogram represents image levels and an ordinate axis of the image level histogram represents a number of pixels of each of the image levels.

3. The image processing method of claim 2, the determining comprises determining the relatively small image level by scanning the level histogram along the abscissa axis from left to right until the number of pixels of the relatively small image level reaches a first threshold value.

4. The image processing method of claim 3, wherein the first threshold value is equal to a total number of pixels of the intermediate image multiplied by a first predetermined percentage.

5. The image processing method of claim 2, the determining comprises determining the relatively large image level by scanning the level histogram along the abscissa axis from right to left until the number of pixels of the relatively large image level reaches a second threshold value.

6. The image processing method of claim 5, wherein the second threshold value is equal to the total number of pixels of the intermediate image multiplied by a second predetermined percentage.

7. The image processing method of claim 1, the adjusting comprises modifying image level of each pixel of the image by using an equation as follows:
$$\{ \begin{matrix}{L}_{out} = {L}_{low} , & ( {L}_{in} \leq {P}_{1} ) \\ {L}_{out} = {L}_{low} + ( {L}_{up} - {L}_{low} ) ( {L}_{in} - {P}_{1} ) / ( {L}_{up} - {P}_{1} ) , & ( {L}_{in} > {P}_{1} )\end{matrix}$$
wherein Lₒᵤₜ represents a modified image level, Lᵢₙ represents an input image level, P₁ represents the relatively small image level, L_{low} represents a lower limit image level, Lᵤₚ represents an upper limit image level.

8. The image processing method of claim 1, the adjusting comprises modifying image level of each pixel of the image by using an equation as follows:
$$\{ \begin{matrix}{L}_{out} = {L}_{up} , & ( {L}_{in} \geq {P}_{2} ) \\ {L}_{out} = {L}_{low} + ( {L}_{up} - {L}_{low} ) ( {L}_{in} - {L}_{low} ) / ( {P}_{2} - {L}_{low} ) , & ( {L}_{in} < {P}_{2} )\end{matrix}$$
where Lₒᵤₜ represents a modified image level, Lᵢₙ represents an input image level, P₂ represents the relatively large image level, L_{low} represents a lower limit image level, Lᵤₚ represents an upper limit image level.

9. The image processing method of claim 1, the adjusting comprises:
modifying image level of each pixel of the image by using an equation as follows:
$$\{ \begin{matrix}{L}_{out} = {L}_{low} , & ( {L}_{in} \leq {P}_{1} ) \\ {L}_{out} = {L}_{low} + ( {L}_{up} - {L}_{low} ) ( {L}_{in} - {P}_{1} ) / ( {L}_{up} - {P}_{1} ) , & ( {L}_{in} > {P}_{1} )\end{matrix}$$
wherein Lₒᵤₜ represents a modified image level, Lᵢₙ represents an input image level, P₁ represents the relatively small image level, L_{low} represents a lower limit image level, Lᵤₚ represents an upper limit image level, and
modifying image level of each pixel of the image by using an equation as follows:
$$\{ \begin{matrix}{L}_{out} = {L}_{up} , & ( {L}_{in} \geq {P}_{2} ) \\ {L}_{out} = {L}_{low} + ( {L}_{up} - {L}_{low} ) ( {L}_{in} - {L}_{low} ) / ( {P}_{2} - {L}_{low} ) , & ( {L}_{in} < {P}_{2} )\end{matrix}$$
where Lₒᵤₜ represents a modified image level, Lᵢₙ represents an input image level, P₂ represents the relatively large image level, L_{low} represents a lower limit image level, Lᵤₚ represents an upper limit image level.

10. An image processing system in an electronic device, the image processing system comprising:
an image obtaining module adapted obtain an image, and to obtain an intermediate image by scaling down the image;
a calculation module adapted to calculate an image level distribution of the intermediate image;
a determination module adapted to determine a relatively small image level and a relatively large image level based on the image level distribution; and
an adjusting module adapted to adjust image levels of pixels of the image according to the relatively small image level and the relatively large image level.

11. The image processing system of claim 10, wherein the calculation module is adapted to generate an image level histogram displaying the image level distribution, where an abscissa axis of the image level histogram represents image levels and an ordinate axis of the image level histogram represents the number of pixels of each of the image levels.

12. The image processing system of claim 11, the determination module is adapted to determine the relatively small image level by scanning the level histogram along the abscissa axis from left to right until the number of pixels of the relatively small image level reaches a first threshold value.

13. The image processing system of claim 12, wherein the first threshold value is equal to a total number of pixels of the intermediate image multiplied by a first predetermined percentage.

14. The image processing system of claim 11, wherein the determination module is adapted to determine the relatively large image level by scanning the level histogram along the abscissa axis from right to left until the number of pixels of the relatively large image level reaches a second threshold value.

15. The image processing system of claim 14, wherein the second threshold value is equal to the total number of pixels of the intermediate image multiplied by a second predetermined percentage.

16. The image processing system of claim 10, wherein the adjusting module is adapted to modify image level of each pixel of the image according to the relatively small image level by using an equation as follows:
$$\{ \begin{matrix}{L}_{out} = {L}_{low} , & ( {L}_{in} \leq {P}_{1} ) \\ {L}_{out} = {L}_{low} + ( {L}_{up} - {L}_{low} ) ( {L}_{in} - {P}_{1} ) / ( {L}_{up} - {P}_{1} ) , & ( {L}_{in} > {P}_{1} )\end{matrix}$$
where Lₒᵤₜ represents a modified image level, Lᵢₙ represents an input image level, P₁ represents the relatively small image level, L_{low} represents a lower limit image level, Lᵤₚ represents an upper limit image level.

17. The image processing system of claim 10, wherein the adjusting module is adapted to modify image level of each pixel of the image according to the relatively large image level by using an equation as follows:
$$\{ \begin{matrix}{L}_{out} = {L}_{up} , & ( {L}_{in} \geq {P}_{2} ) \\ {L}_{out} = {L}_{low} + ( {L}_{up} - {L}_{low} ) ( {L}_{in} - {L}_{low} ) / ( {P}_{2} - {L}_{low} ) , & ( {L}_{in} < {P}_{2} )\end{matrix}$$
where Lₒᵤₜ represents a modified image level, Lᵢₙ represents an input image level, P₂ represents the relatively large image level, L_{low} represents a lower limit image level, Lᵤₚ represents an upper limit image level.

18. The image processing system of claim 10, wherein the adjusting module is adapted to modify image level of each pixel of the image according to the relatively small image level by using an equation as follows:
$$\{ \begin{matrix}{L}_{out} = {L}_{low} , & ( {L}_{in} \leq {P}_{1} ) \\ {L}_{out} = {L}_{low} + ( {L}_{up} - {L}_{low} ) ( {L}_{in} - {P}_{1} ) / ( {L}_{up} - {P}_{1} ) , & ( {L}_{in} > {P}_{1} )\end{matrix}$$
where Lₒᵤₜ represents a modified image level, Lᵢₙ represents an input image level, P₁ represents the relatively small image level, L_{low} represents a lower limit image level, Lᵤₚ represents an upper limit image level, and
the adjusting module is further adapted to modify image level of each pixel of the image according to the relatively large image level by using an equation as follows:
$$\{ \begin{matrix}{L}_{out} = {L}_{up} , & ( {L}_{in} \geq {P}_{2} ) \\ {L}_{out} = {L}_{low} + ( {L}_{up} - {L}_{low} ) ( {L}_{in} - {L}_{low} ) / ( {P}_{2} - {L}_{low} ) , & ( {L}_{in} < {P}_{2} )\end{matrix}$$
where Lₒᵤₜ represents a modified image level, Lᵢₙ represents an input image level, P₂ represents the relatively large image level, L_{low} represents a lower limit image level, Lᵤₚ represents an upper limit image level.

19. An image processing method executable on a computer, the image processing method comprising:
providing an image obtaining module, a calculation module, a determination module, and an adjusting module;
obtaining an image and an intermediate image by scaling down the image by the image obtaining module;
calculating an image level distribution of the intermediate image by the calculation module;
determining a relatively small image level and a relatively large image level based on the image level distribution by the determination module; and
adjusting image levels of pixels of the image according to the relatively small image level and the relatively large image level by the adjusting module.
